(19) United States
(12) Patent Application Publication
(10) Pub. No.: US 2026/0289720 A1
(43) Pub. Date: Sep. 24, 2026

(54) Degraded Quality Image Buffer Fallback

(71) Applicant: Apple Inc., Cupertino, CA (US)

(72) Inventors: Peter A. Lisherness, Los Gatos, CA (US); Nathaniel C. Begeman, Saratoga, CA (US)

(21) Appl. No.: 19/086,118

(22) Filed: Mar. 20, 2025

(51) Int. Cl. G06T 1/60; G06F 3/14; G06T 1/20; G06T 5/80; G06T 7/00; G06T 9/00

(52) U.S. Cl. CPC G06T 1/60; G06F 3/14; G06T 1/20; G06T 5/80; G06T 7/0002; G06T 9/00; G06T 2207/30168

(57) ABSTRACT

Systems, methods, and devices are provided to reduce latency in displaying image data on an electronic display. This may include instructing image processing circuitry to read a first tile of image data from a first framebuffer, determining whether the first framebuffer or a second framebuffer has a higher quality second tile after the first tile and, based on whether the first framebuffer or the second framebuffer has the higher quality second tile, instructing the image processing circuitry to read the second tile from the first framebuffer or the second framebuffer that has the higher quality second tile.

### BACKGROUND

This disclosure is directed to systems and methods for rapidly rendering and displaying graphics with tile granularity based on a quality of a next tile or tile row in a framebuffer.

The latency of displaying rendered image content to a user is a critical parameter in augmented reality (AR) or virtual reality (VR) systems, and also of great importance in gaming applications. Techniques such as "VSYNC off" attempt to shorten this time by switching over to new content as soon as it is available, with the understanding that this could result in artifacts at the switchover boundaries where the previous content misaligns. It is worth noting that in these techniques, scanout is assumed to start from the older image and then cut over to the newer image once the entirenewer image is complete. Thus, although disabling “vsync” may reduce latency, the entire current frame must be rendered before the display controller switches to the new frame. Further, a key underpinning of the existing techniques is that the images are separated in time: an older image and a newer one, with priority given to the newer one. As such, existing techniques may not be suitable for use in some systems, such as AR/VR systems where mixing new and old images could create a negative user experience.

### SUMMARY

Some graphics processing units (GPUs) may render the frame as a series of image data tiles smaller than the full frame the display controller consumes. These tiles are completed in an arbitrary order and at arbitrary times. Rendering image data with tile granularity (e.g., on a tile-by-tile basis) may further minimize latency compared to traditional whole-frame rendering. Embodiments disclosed herein are directed to selecting tiles of image data of a frame of image data to display based on an image quality level of the tiles. The display controller may decide on a tile-by-tile basis or a tile row-by-tile row basis whether to fetch image data for display from one framebuffer or another. In this way, the display controller does not have to wait for the image frame to finish rendering at the highest quality level before beginning to display the completed tiles, thereby reducing the latency beyond that offered by full-frame vsync-off. As a result, a new visual artifact may be created that is different from the “screen tearing” typically seen with vsync-off. This new visual artifact may provide a “signature look” that represents that a user is getting a very low latency (potentially even the lowest possible latency).

In particular, this disclosure proposes mixing higher- and lower-quality image data with priority given to one image based on quality. In a multi-pass rendering pipeline, it may be acceptable, even unnoticeable, to substitute the content of an earlier GPU pass (e.g., a lower-quality render) for part of the image. Additionally or alternatively, a lower-quality readout (e.g., lower resolution, bit depth, scene complexity) with tiles subjected to fewer rendering effects could be read out in its entirety (e.g., for the full frame) before beginning scanout (e.g., updating each pixel on display). The scanout may provide a more detailed version of the lower-quality content and opportunistically substituted in during the scanout time. The methods described herein may be particularly useful for AR/VR applications where the spatio-temporal artifacts of mixing two sequential frames may be unacceptable, yet the occasional and slight quality degradation of the image, partial or whole, may not even be noticeable and, therefore, worth the ability to start scanout quicker. Further, this technique may be applied to prioritize the generation and readout of the higher-quality content in particular regions of an image. For example, regions where the user's gaze (e.g., detected gaze, predicted gaze) is expected to have greater visual acuity may be prioritized for higher-quality image data since the user may be more likely to notice a disparity between lower- and higher-quality data.

### BRIEF DESCRIPTION OF THE DRAWINGS

Various aspects of this disclosure may be better understood upon reading the following detailed description and upon reference to the drawings in which:

FIG. 1 is a schematic diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a headset, in accordance with an embodiment;

FIG. 7 is a block diagram of a system for displaying image content on an electronic device via a double framebuffer, in accordance with an embodiment;

FIG. 8 is a flowchart of an example process for displaying image content on a tile-by-tile basis via a multi-framebuffer system, in accordance with an embodiment;

FIG. 9 is a block diagram of a first tile of image content being read for display on an electronic device on a tile-by-tile basis, in accordance with an embodiment;

FIG. 10 is a block diagram of a first tile of image content being read for display on an electronic device on a tile-by-tile basis, in accordance with an embodiment;

FIG. 11 is a block diagram of a first tile of image content being read by image data for display on a tile-by-tile basis, in accordance with an embodiment;

FIG. 12 is a block diagram of a first tile of image content being read by image data for display on a tile-by-tile basis, in accordance with an embodiment; and

FIG. 13 is a block diagram of a first tile of image content being read by image data for display on a tile-by-tile basis, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Electronic devices often use electronic displays to present visual information or image content. Examples of such electronic devices may include computers, mobile phones, portable media devices, tablets, televisions, virtual-reality headsets, and vehicle dashboards, among many others. Such electronic devices may have a display controller, display engine, display interface, or the like that may operate to turn digital display data into the image content viewed by a user on the display. Additionally, such electronic devices may have one or more memory components, such as a framebuffer (e.g., a framestore), to hold the image data associated with the image content to be displayed on the electronic display. As a user interacts with the electronic device, new image data may be generated. The GPU may generate, update, and store the new image data via one or more framebuffers until the image data is read out and displayed.

As used herein, “minimal latency” refers to a reduced latency that, in some cases, may be the smallest delay possible when transmitting image data between a source (e.g., a framebuffer) and a destination (e.g., an electronic display). Latency is often measured in milliseconds and may vary depending on the image content application. For example, latency in the context of web browsing may be longer versus latency in the context of real-time communication or online gaming without apparent advantages or disadvantages to the user. Embodiments disclosed herein are directed to a relationship between the GPU and the display controller that may allow the display controller to indicate to the display which tiles of a frame to display based on an indication from the GPU regarding which tiles have completed rendering, or are ready for readout, even before the current frame has entirely rendered, thereby achieving reduced (e.g., minimal) latency.

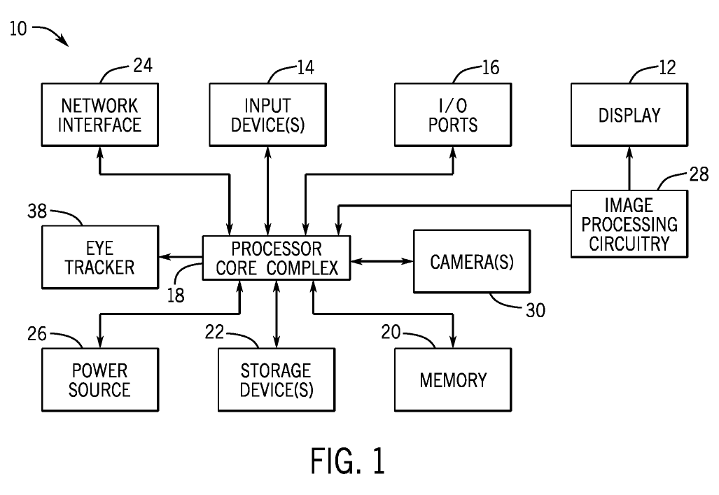

With the foregoing in mind, FIG. 1 is an example electronic device 10 with an electronic display 12 that may display image content for viewing by a user. As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, a power supply 26, image processing circuitry 28, one or more cameras 30, and an eye tracker 38. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a GPU, a display image processing pipeline, a display controller) may be included in the processor core complex 18, the electronic display 12, or implemented separately. Although not shown, in another embodiment, a GPU may be implemented separately or as part of the image processing circuitry 28. In another embodiment, the GPU may be part of the processor core complex 18.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a BLUETOOTH® network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices, such as one or more input devices 14, for example. The input devices 14 may enable a user to interact with the electronic device 10 and may include microphones, cameras, displays, buttons, keyboards, mice, trackpads, and the like. Additionally or alternatively, the electronic display 12 may include touch sensing components that enable user inputs to the electronic device 10 by detecting occurrence and/or position of an object touching its screen (e.g., surface of the electronic display 12).

The one or more cameras 30 may include image sensors that convert light into an electronic signal that may be processed into an image for display on the electronic display 12. The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). As used herein, each display pixel corresponds to one sub-pixel (e.g., a red, green, or blue subpixel).

The eye tracker 38 may measure positions and movement of one or both eyes of a person viewing the electronic display 12 of the electronic device 10. As used herein, the eye tracker 38 may be any suitable component for measuring and/or monitoring positions and/or movement of one or both eyes of a person viewing the electronic display 12 (e.g., a user) of the electronic device 10, such as a video camera, a light detection and ranging (LIDAR) sensor, a depth sensor, electrical potential sensors, and/or software recognition techniques. For instance, the eye tracker 38 may be a camera that records the movement of a viewer’s eye(s) as the viewer looks at the electronic display 12. However, several different practices, techniques, and/or components may be employed to track a viewer’s eye movements. For example, different types of infrared/near infrared eye tracking techniques such as bright-pupil tracking and dark-pupil tracking may be used. In these types of eye tracking, infrared or near infrared light is reflected off of one or both of the eyes of the viewer to create corneal reflections.

A vector between the center of the pupil of the eye and the corneal reflections may be used to determine a point on the electronic display 12 at which the viewer is looking. Moreover, as discussed below, varying portions of the electronic display 12 may be used to show content in relatively higher and lower luminance level portions based at least in part on the point of the electronic display 12 at which the viewer is looking.

As described above, the electronic display 12 may display an image by controlling the luminance output (e.g., light emission) of the sub-pixels based on corresponding image data. In some embodiments, pixel or image data may be generated by or received from an image source, such as the processor core complex 18, a graphics processing unit (GPU), storage device 22, or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 16.

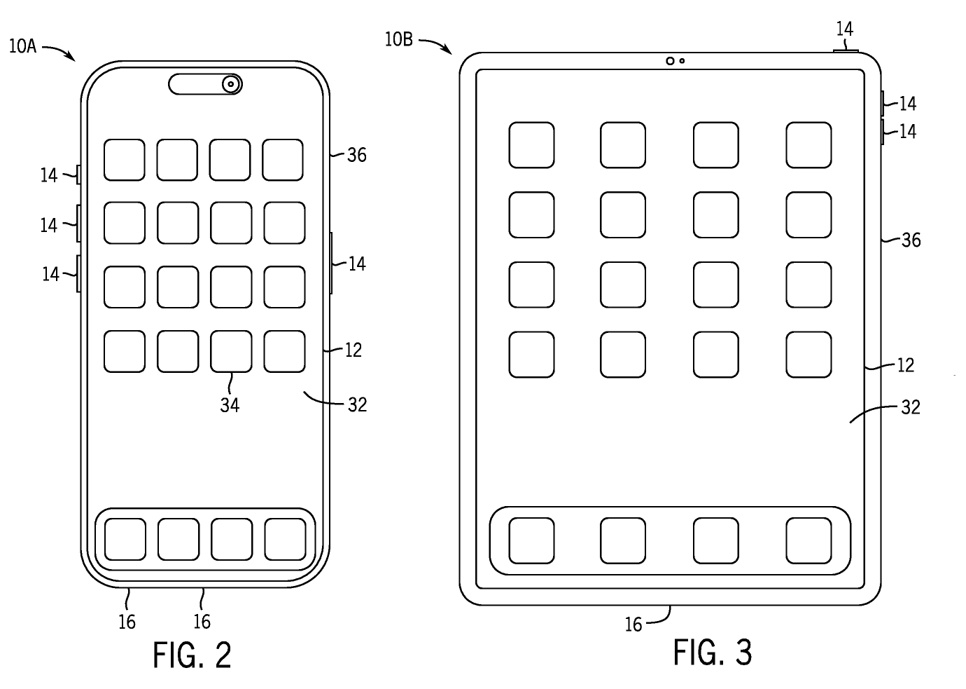

As described above, the electronic device 10 may be any suitable electronic device. To help illustrate one example of a suitable electronic device 10, FIG. 2 shows the electronic device 10 as a handheld device 10A. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 36 (e.g., housing) to, for example, protect interior components from physical damage and/or shield them from electromagnetic interference. The enclosure 36 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 36. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may also open through the enclosure 36. Additionally, the electronic device may include one or more cameras 30 to capture pictures or video. In some embodiments, a camera 30 may be used in conjunction with a virtual reality or augmented reality visualization on the electronic display 12. Another example of a suitable electronic device 10, specifically a tablet device 10B, is shown in FIG. 3. For illustration purposes, the tablet device 10B may be any IPAD® model available from Apple Inc. The tablet device 10B may include similar components to the handheld device 10A and operate in a similar manner as described with respect to the handheld device 10A.

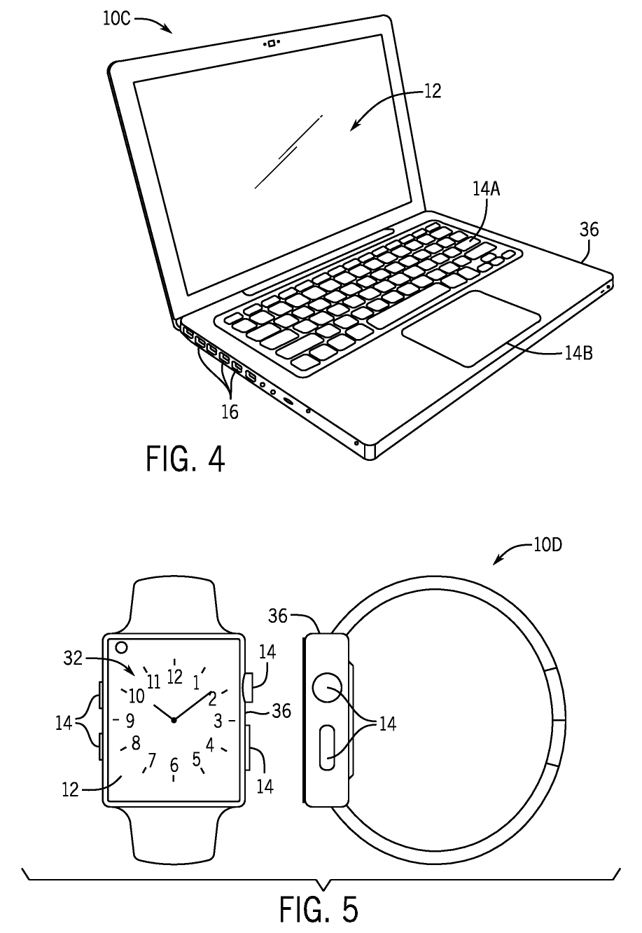

A further example of a suitable electronic device 10, specifically a computer 10C, is shown in FIG. 4. The computer 10C may be any suitable computer, such as a desktop computer, a server, a laptop computer, or a notebook computer, but may also be a standalone media player or video gaming machine. By way of example, the computer 10C may be an IMAC®, a MACBOOK®, or other similar device by Apple Inc. It should be noted that the computer 10C may also represent a personal computer (PC) by another manufacturer. Similar to the handheld device 10A and the tablet device 10B, the computer 10C may include one or more I/O ports 16 as well as an enclosure 36 to protect and enclose components of the computer 10C, such as the electronic display 12. In certain embodiments, a user of the computer 10C may interact with the computer 10C using various peripheral input devices 14, such as a keyboard 14A or a mouse or touchpad 14B, which may connect to the computer 10C.

Another example of a suitable electronic device 10, specifically a watch 10D, is shown in FIG. 5. For illustrative purposes, the watch 10D may be an APPLE WATCH® model available from Apple Inc. As depicted, the watch 10D may include an electronic display 12, input devices 14, I/O ports 16, and an enclosure 36. The electronic display 12 may display a GUI 32. In FIG. 5, the GUI 32 shows a visualization of a clock. When the visualization is selected either by the input device 14 or a touch-sensing component of the electronic display 12, an application program may launch, such as to transition the GUI 32 to presenting one or more icons 34 similar to those discussed in FIGS. 2 and 3 with respect to the handheld device 10A and the tablet device 10B, respectively.

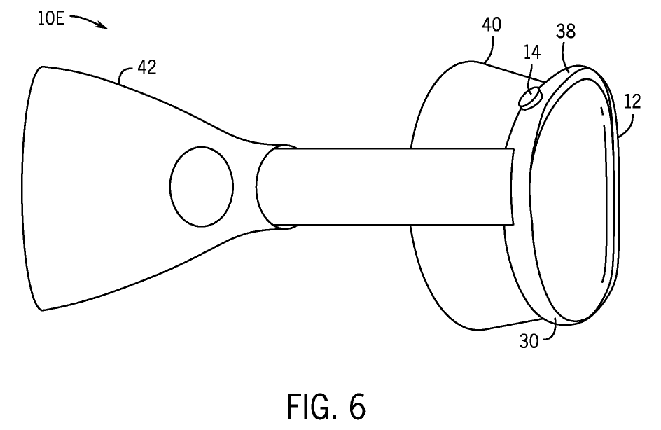

A further example of a suitable electronic device 10, specifically a virtual-reality headset 10E, is shown in FIG. 6. For illustrative purposes, the headset 10E may be an APPLE VISION PRO® model available from Apple Inc. As with the above examples of an electronic device 10A-10D, the headset 10E may also include an electronic display 12, input devices 14, I/O ports 16, and an enclosure 36. Additionally or alternatively, the headset 10E may include a light seal 40 and/or a band 42 to fasten the device on a user’s head. In some embodiments, the headset 10E may include one or more eye tracker devices 38 to determine which portions of the display 12 are being viewed by the user, including, for example, which portions of the display 12 are frequently viewed by the user and/or which portions of the display 12 are in the user’s central vision and which portions of the display 12 are in the user’s peripheral vision.

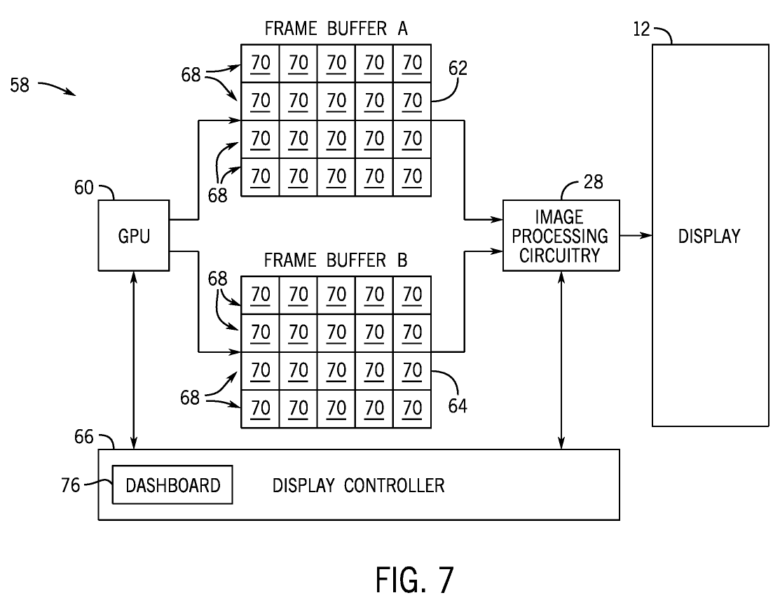

To help illustrate how latency may be reduced (e.g., minimized) via tile-based rendering, FIG. 7 shows an overview of a data processing system 58 for displaying image content on an electronic device 10 via a double framebuffer. It should be noted that, although FIG. 7 shows a double-framebuffer system, the system 58 may include any suitable number of framebuffers. Each framebuffer 62, 64 may be a component or a region in the system memory 20 that stores tiles 70 of image data for display. Each framebuffer 62, 64 may include multiple tile rows 68, and each tile row 68 may include multiple such tiles 70. The tiles 70 of image data may be generated by a graphics processing unit (GPU) 60 and may correspond to a portion of one frame of image content for display on the electronic display 12.

The GPU 60 may be communicatively coupled to a display controller 66 and may generate the tiles 70 of image data and write the tiles 70 into memory (e.g., into one of the framebuffers 62, 64) in communication with the controller 66. The GPU 60 may write the tiles 70 to the framebuffer 62 or 64 in any order (e.g., an arbitrary order, raster order). The display controller 66 may include a processor (e.g., a Reduced Instruction Set Computer (RISC) microprocessor) that executes firmware instructions stored in memory (e.g., in dedicated memory of the display controller 66 or the memory 20 or storage 22 shown in FIG. 1). Additionally or alternatively, the display controller 66 may include a finite state machine (FSM). Once the GPU 60 finishes writing all the tiles 70 corresponding to one frame to the framebuffer 62 or 64, the GPU 60 may switch to writing new tiles 70 corresponding to the next frame to the other framebuffer 64 or 62. The tiles 70, when generated by the GPU, may include compressed image data that can be decompressed and displayed. For example, although not shown, the tiles 70 may include multiple lines of compressed image data made up of several pixels for the region of the tile. The image processing circuitry 28 may also be communicatively coupled to the display controller 66 and may read each tile 70 in the tile row 68 based on communication with the controller 66. For example, each tile 70 may be read one at a time (e.g., on a tile-by-tile basis), as it may be more efficient to encode a whole tile of pixels at one time compared to a whole line of pixels across multiple tiles in a row (e.g., on a line-by-line basis).

When the tiles 70 are later read from one of the framebuffers 62, 64, they may be decompressed and displayed. For example, the display controller 66 may cause the tiles 70 to be read out by the image processing circuitry 28 from the framebuffer 62, 64 by causing the image processing circuitry 28 to read and extract the compressed image data and decompress it prior to processing the image data and sending it to the display panel 12. As previously mentioned, the tiles 70 may be read into the image processing circuitry 28 in raster order, and, as such, the image data may be presented on the display 12 in raster order. It should be noted, however, that the image processing circuitry 28 (e.g., via the display controller 66) may be configured to readout the image data in any order, at a particular time interval, and/or from a particular region of the electronic display 12.

In an embodiment, as the GPU 60 generates new tiles 70 and writes them into memory, the display controller 66 may receive an indication from the GPU 60 regarding whether each tile is ready for readout. As the GPU 60 generates and writes new tiles 70, it may communicate to the display controller 66 an indication of a status of each tile 70. For example, in embodiments where readout is determined based on image quality (e.g. a threshold of quality and/or a minimum quality approved for readout), the display controller 66 may receive an indication of a quality of the image data rendered in each tile 70 written into memory. In some cases, the indication of the quality of the image data may be provided based on a determined resolution of the rendered image data (e.g. a threshold resolution and/or a minimum resolution). Additionally or alternatively, the indication may be provided based on a determination of whether a tile has undergone certain GPU refinements (e.g., chromatic aberration correction) or has made it to a particular processing “checkpoint.” As such, the indication may pertain to a rendering or correction “stage” of each tile 70 (e.g. whether the tile has been processed for chromatic aberration correction) and/or which tile 70 is most recently generated (e.g., including a timestamp or a frame number associated with the tile). In some cases, the display controller 66 may use a dashboard 76 (e.g., written to by the GPU 60) to track the status of each tile 70 (e.g., which of the tiles 70 are new/old, what rendering effects have been applied to each tile 70, the quality of image data of each tile). The term “dashboard,” as used herein, may refer to any suitable data structure in memory (e.g., in dedicated memory of the display controller 66 of FIG. 7 or the memory 20 or storage 22 shown in FIG. 1) that maintains and indicates the status of the image data stored of the tiles in the various memory addresses of the framebuffers 62 and 64. In some cases, the dashboard 76 may take the form of a memory validity bitmap or table.

In other cases, the tiles 70 may be associated with bits of memory that indicate whether the tiles 70 are marked as valid or invalid based on, for example, a recency with which each tile was rendered. In that case, the GPU 60 or the display controller 66 may mark tiles 70 corresponding to a new frame as valid as they are written into one of the framebuffers 62, 64. In such cases, the GPU 60 may fill one of the framebuffers 62, 64 with new tiles 70, which may be marked as new in the dashboard 76 or in framebuffer memory using valid bits. Additionally or alternatively, the GPU 60 or the display controller 66 may mark tiles 70 corresponding to an old frame as invalid.

The display controller 66, which may be communicatively coupled to the image processing circuitry 28, may control which framebuffer 62, 64 the image processing circuitry 28 reads from based on the indication from the GPU 60 (e.g., via the dashboard 76). The indication from the GPU 60 may include information such as which framebuffer 62, 64 and tile row 68 the next valid tile 70 is written or stored in and, therefore, which framebuffer 62, 64 the image processing circuitry 28 should read from. In this way, the controller 66 may cause the image processing circuitry 28 to read from the tile row 68 in the framebuffer 62, 64 with the next valid tile 70. Additionally or alternatively, in some embodiments, the framebuffer 62, 64 may be read by the display controller 66.

The image processing circuitry 28 may include a display pipeline that prepares image data for display on the display 12. The image processing circuitry 28 may read and extract each tile 70 in the indicated tile row 68 that is ready to be read or may read one tile 70 at a time from whichever framebuffer 62, 64 has the next valid tile 70. To explain further, in one embodiment, the GPU 60 may write into a particular framebuffer 62, 64. The GPU 60 may write tiles 70 into one framebuffer 62, 64 at a time, filling the framebuffer 62, 64 with tiles 70 corresponding to a particular image frame. But because the GPU 60 may be capable of generating frames faster than the display 12 can display them, the GPU 60 may begin writing to the next framebuffer 64, 62 as soon as it has filled the previous framebuffer 62, 64. In this way, the GPU 60 may sometimes, but not always, write tiles 70 into an idle framebuffer 62, 64. The term “idle framebuffer” may refer to the framebuffer 62, 64 that is not currently being read by the image processing circuitry 28. Indeed, in some cases, the GPU 60 may write new tiles 70 into the framebuffer 62, 64 that is currently being read, which may be referred to as an “active framebuffer.” The term “active framebuffer” may refer to the framebuffer 62, 64 that is currently being read by the image processing circuitry 28 to render the image data onto the display screen.

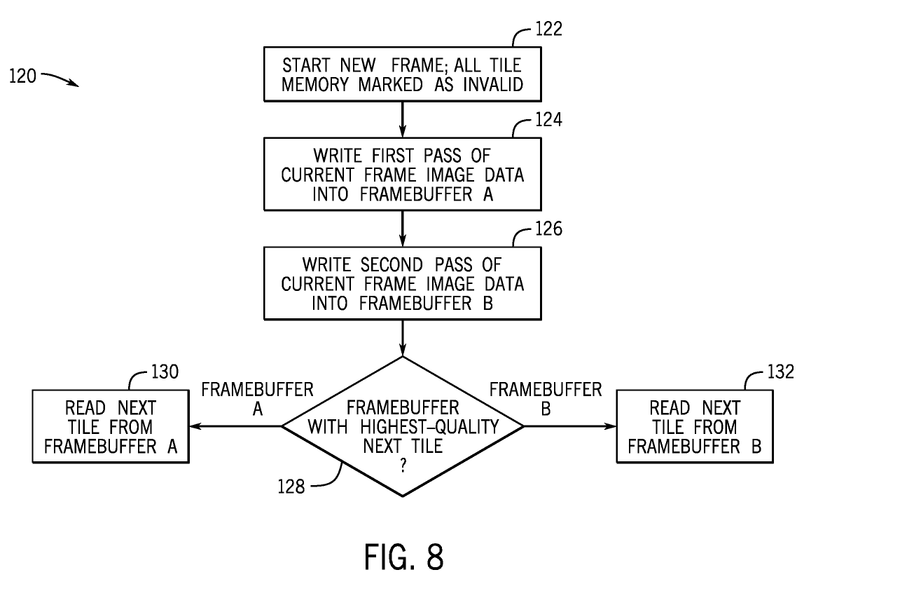

To further illustrate how the data processing system 58 of FIG. 7 may reduce latency in a multi-framebuffer system, FIG. 8 provides an example process 120 for displaying image content on a tile-by-tile basis, or tile row-by-tile row basis, based on image quality. For example, at the start of a new frame, all tile memory corresponding to the old frame may be default-marked as invalid and, therefore, may signal to the display controller 66 that the tiles 70 are not ready for readout (block 122). The GPU 60 may begin to write a first pass of the new (e.g., current) frame into one of the framebuffers (e.g., Framebuffer A 62) (block 124). Additionally or alternatively, in some embodiments, the first pass of tiles 70 of the new frame may be written into memory directly from a subsystem associated with the electronic device 10 and capable of capturing, generating, and/or retrieving image data. For example, the subsystem may be a camera 30. Image data captured by the camera 30 may be directly written into the framebuffer as it is generated. In another example, the subsystem may be another source of memory via direct memory access (DMA). Occurring subsequent to or concurrently with the first pass, the GPU 60 may write a second pass of the tiles 70 of the new frame into a different framebuffer (e.g., Framebuffer B 64) (block 126). The second pass may provide the GPU 60 an opportunity to correct or further process the tiles 70 to improve the quality. In this way, the higher quality image data is generated via the second pass after the lower quality image data is rendered and written into memory. The tiles 70 may then be read by the image processing circuitry 28 (e.g., based on instructions from the display controller 66) for display on the electronic display based on which framebuffer (e.g., A or B) has the highest quality next-tile (e.g., a valid tile that comes next in raster order) (block 128). For example, the display controller 66 may determine which framebuffer of the multi-framebuffer system (e.g., Framebuffer A 62 or Framebuffer B 64) has the highest quality tile corresponding to a next tile (e.g., a second tile in raster order after the first tile). In some embodiments, this may be performed based on which framebuffer has the next-tile (e.g., the tile that comes next in raster order) with valid bits. When the framebuffer A 62 has the highest quality next-tile, the display controller 66 may instruct the image processing circuitry 28 to read the next-tile from the Framebuffer A 62 (block 130). When the framebuffer B 64 has the highest quality next-tile, the display controller 66 may instruct the image processing circuitry 28 to read the next-tile from the Framebuffer B 64 (block 132). In another example, entire tile rows may be read rather than individual tiles. For example, the tile row that comes next in raster order may be selected to be read from either the Framebuffer A 62 or the Framebuffer B 64 based on which framebuffer has the highest quality tile or tiles in the tile row that is next in raster order (e.g., that also may not have any invalid tiles corresponding to tiles for a prior frame). It should be noted that, in some embodiments, the next-tile or next tile row may be the tile or tile row that comes next in an order that is not raster order.

Therefore, by the embodiments described herein, readout may be controlled based on the quality of image data in each tile; as long as the tile or tile row that comes next in the order meets a certain quality threshold, the display controller 66 may instruct the image processing circuitry 28 to read that tile into the display. In this way, users may experience reduced (e.g., minimized) latency because readout may be controlled to not stall even when the image quality does not meet a preferred quality threshold, but rather meets an accepted threshold (e.g., a tile may forego final stages of correction but still be indicated as ready for readout). With this in mind, it may be possible that, in some embodiments, the tiles 70 may be read for display after the first pass and before the second pass is rendered. As long as the image quality is within an accepted threshold, tiles from the first pass may be displayed before a higher quality rendering is available, thereby preventing delays in the display. As such, tiles rendered in the first pass may referred to as an intermediate display product that serves as a backup when preferred image content is not yet available for display. In such cases, as soon as higher quality (e.g., preferred quality) tiles are rendered in the second pass, and are therefore marked as having higher quality, the display controller 66 may determine which framebuffer of the multi-framebuffer system (e.g., Framebuffer A 62 or Framebuffer B 64) has the second pass (e.g., higher quality, highest quality) tiles that correspond to a next-tile (e.g., a second tile that follows a first tile in a given order, such as raster order) and instruct the image processing circuitry 28 to read from that framebuffer.

Although not shown, it should be noted that additional passes of each tile may be rendered by the GPU to continue improving the quality of data until a preferred quality is achieved. In this way, the techniques described herein may provide the benefit of reducing power consumed by the GPU, as each pass subsequent to the first may require less and less power to render. Further, although not shown, it is possible that additional passes may be performed by hardware other than the GPU 60.

The benefits of prioritizing quality to reduce latency as outlined above may be particularly evident in AR/VR applications where viewing the most recent image data, without mixing new and old image data, may be imperative for creating a pleasant user experience. For example, some AR/VR systems (e.g., a headset, goggles, glasses) may be worn or otherwise positioned over the user’s eyes, yet may enable users to continue to view their surroundings via a display of the system. Such systems may be able to display image data (e.g., taken from a camera of the system) of the user’s surroundings such that the user may see their environment during use of the system. Therefore, to create a more seamless experience for the user during use of the system, it may be preferable to display the most recent image data of the user’s real-time surroundings than to display older image data that does not reflect the user’s real-time surroundings. Even if the most recent image data is of slightly lower quality compared to the older image data, a user’s experience may be improved more by a reduction in latency than a guarantee of high-quality data.

In addition to these benefits, minimal latency may improve overall user experience with AR/VR systems as well as with other systems employing electronic displays. This may particularly be true in cases where quality-based latency is applied to particular regions of the display and/or particular levels of correction that are less noticeable to the human eye. For example, the techniques described herein may be applied such that the display controller performs the readout of tiles from the framebuffer in an arbitrary order (e.g., not raster order) and from an arbitrary portion of the framebuffer. In such cases, the image data may be read out in a manner that displays the highest resolution tiles first (e.g., 300 pixels per inch (PPI) or greater) and that correspond to portions of the display the user’s eye is likely to focus on most. For example, a user’s eyes may be tracked via the one or more eye trackers 38 to determine which portions of the display the user looks at the most. Alternatively or additionally, the lowest quality tiles may be read out where the user’s eye is less likely to pick up on quality differences (e.g., peripheral view). In this way, the readout is not delayed by a second pass or a scanout of the rendered data and the user’s experience is not changed or hindered compared to when the data is fully rendered in the highest quality.

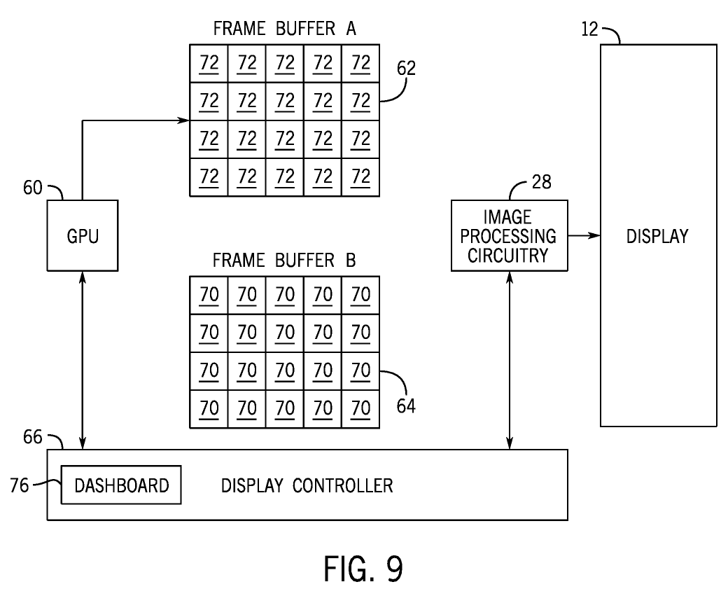

FIG. 9 illustrates a block diagram of an example embodiment of the above-described process 120 for displaying image content on an electronic device 10 on a tile-by-tile basis. In the example of FIGS. 9–13, the tiles 70 may correspond to image content of a first type (e.g., lower quality or higher quality), tiles 72 may correspond to image content of a second type, and tiles 74 may correspond to image content of a third type. As such, the tiles 70, 72, and 74 may correspond to the same or different frames and/or may represent image data of varying degrees of quality. Consistent with the above-described process 120 for displaying image content, in the example of FIG. 9, tiles 70 in Framebuffer B 64 may correspond to a first frame older than a second, newer frame corresponding to tiles 72, which are shown being written into Framebuffer A 62 by the GPU 60 in a first pass. In the embodiment illustrated by FIG. 9, all tile memory may be marked as invalid and is, therefore, not shown being read by the image processing circuitry 28. The image processing circuitry 28 is shown to be in communication with the display controller 66 to receive instruction from the display controller 66 regarding which framebuffer to read from based on an indication from the GPU 60. Meanwhile, the GPU 60 is writing the new frame of tiles 72 into the Framebuffer A 62. Subsequent to or concurrently with writing the tiles 72, the GPU 60 may provide the display controller 66 an indication (e.g., via the dashboard) regarding a status of each tile 72.

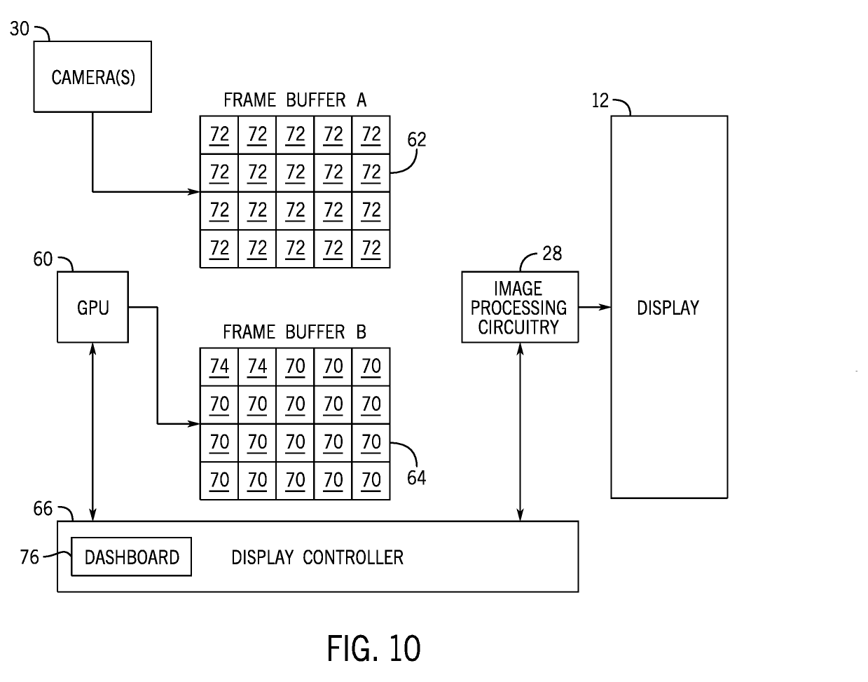

FIG. 10 illustrates another example where, as mentioned above with respect to FIG. 8, the first pass of new tiles 72 may be written into memory directly from a subsystem other than, or in addition to, the GPU 60. In the illustrated example of FIG. 10, the first pass of the new tiles 72 are being written into Framebuffer A 62 directly from the camera 30 of the electronic device 10.

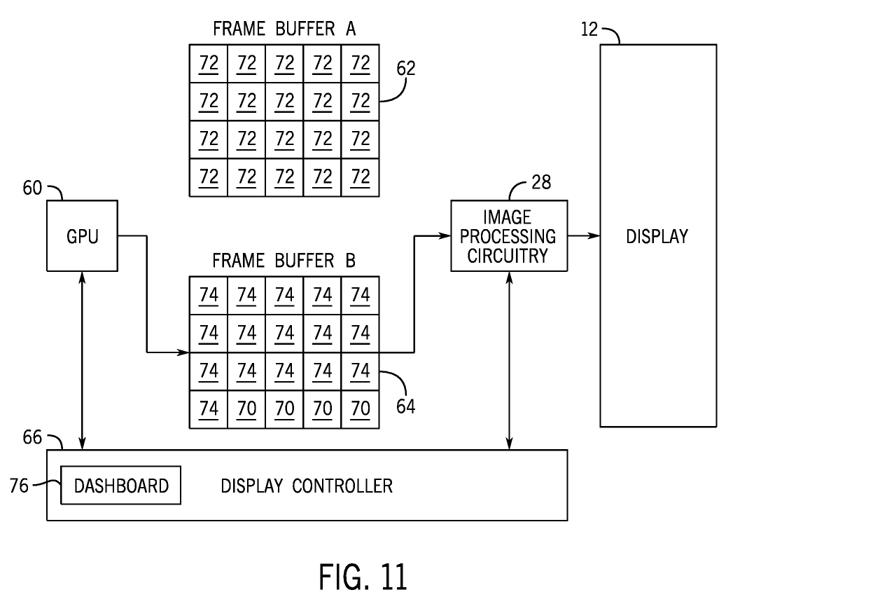

In either case, FIG. 11 illustrates the beginning of the readout of the new frame. Subsequent to or concurrently with the first pass, the GPU 60 may write a second pass of the tiles 74 of the current frame into Framebuffer B 64. The tiles 74 may correspond to higher quality image data and may, therefore, be the preferred tiles for display. As such, as shown in FIG. 11, the image processing circuitry 28 may read out the tiles 74 from Framebuffer B 64 in response to receiving an indication (e.g., from the display controller 66 or the dashboard 76) that Framebuffer B 64 contains the highest quality data (e.g., tiles 74).

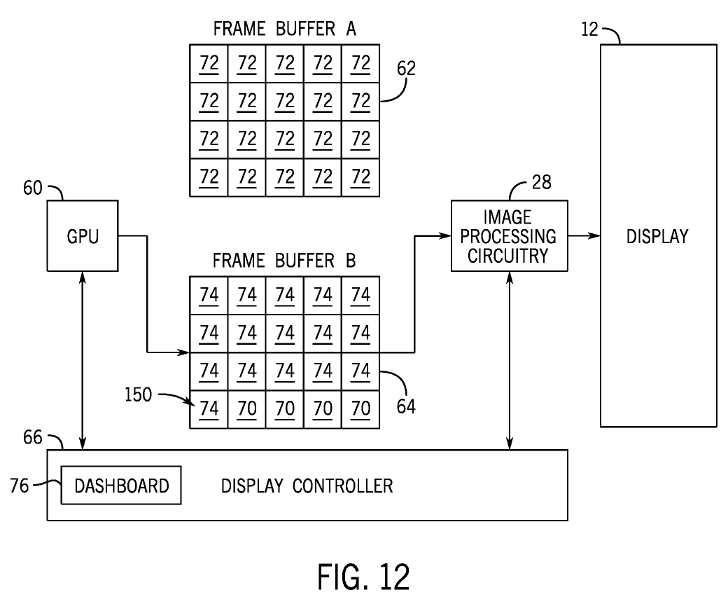

Continuing with this example, in FIG. 12, the display controller 66 may preferentially instruct readout of the second-pass tiles 74 from the framebuffer storing the second-pass tiles 74. For example, looking at FIG. 12, the display controller 66 may instruct readout of the second-pass tiles 74 from Framebuffer B 64 in raster order. This may continue through reading a highest quality next-tile 150. Beyond the tile 150, the GPU 60 has not yet written new second-pass tiles 74 into the Framebuffer B 64 — at this point, the remainder of the Framebuffer B 64 only includes invalid tiles 70 (e.g., corresponding to old image data from a previous frame).

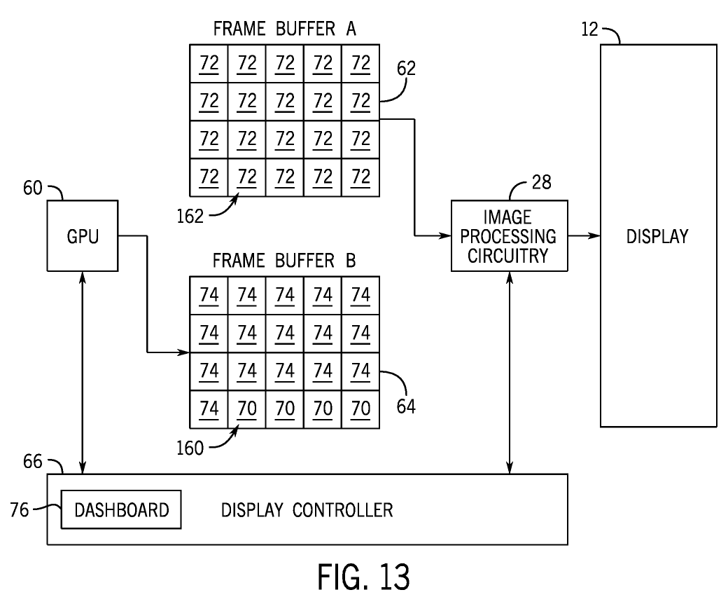

Accordingly, as shown in FIG. 13, the image processing circuitry 28 may stop reading from the Framebuffer B 64 to avoid reading an invalid next-tile 160 and instead begin to read a valid, but lower-quality, next-tile 162 from the Framebuffer A 62 that includes a first-pass tile 72. As the image processing circuitry 28 reads from the Framebuffer A 62, the GPU 60 may continue to write (e.g., render in a second pass) second-pass tiles 74 into Framebuffer B 64. As such, the image processing circuitry 28 may switch back to using the Framebuffer B 64 for subsequent tiles if those higher-quality tiles are available. In this way, the multi-framebuffer system and the quality-based latency techniques disclosed herein communicatively connect the GPU 60 and the display controller 66 such that the display controller 66 may provide continuous display of image data without delay due to lower-quality renders by selecting the next, best-quality tile without interrupting the rendering of higher quality tiles.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to reduce risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. An article of manufacture comprising tangible, non-transitory, machine-readable media comprising instructions that, when executed by a data processing system, cause the data processing system to carry out operations comprising:
instructing image processing circuitry to read a first tile of image data from a first framebuffer;
determining whether the first framebuffer or a second framebuffer has a higher-quality second tile after the first tile; and
based on whether the first framebuffer or the second framebuffer has the higher-quality second tile, instructing the image processing circuitry to read the second tile from the first framebuffer or the second framebuffer that has the higher-quality second tile.

2. The article of manufacture of claim 1, wherein determining whether the first framebuffer or the second framebuffer has the higher-quality second tile comprises receiving an indication identifying the higher-quality tile from a graphics processing unit (GPU).

3. The article of manufacture of claim 1, wherein determining whether the first framebuffer or the second framebuffer has the higher-quality second tile comprises reading a dashboard of tile completion indicating a quality of each tile stored in the first framebuffer and the second framebuffer.

4. The article of manufacture of claim 3, wherein the quality of each tile is based on one or more graphics processing unit (GPU) refinements associated with each tile.

5. The article of manufacture of claim 4, wherein the one or more GPU refinements comprises chromatic aberration correction.

6. The article of manufacture of claim 1, wherein determining whether the first framebuffer or the second framebuffer has the higher-quality second tile comprises inspecting contents of the first framebuffer or the second framebuffer to identify whether there is valid data corresponding to the second tile available.

7. The article of manufacture of claim 1, wherein the operations comprise comparing a quality of the second tile to a threshold of quality prior to instructing the image processing circuitry to read the second tile.

8. The article of manufacture of claim 7, wherein the threshold of quality comprises a threshold resolution.

9. The article of manufacture of claim 1, wherein the second tile is immediately after the first tile in raster order.

10. The article of manufacture of claim 1, wherein the second tile is part of the same tile row as the first tile.

11. The article of manufacture of claim 1, wherein the first tile and the second tile comprise compressed image data.

12. An electronic device comprising:
a graphics processing unit (GPU) configured to generate tiles of image data;
memory to comprise a plurality of framebuffers configured to store the tiles; and
an electronic display configured to display image data from one or more of the tiles stored in a selected one of the plurality of framebuffers based on which framebuffer of the plurality of framebuffers has a highest-quality version of the one or more of the tiles of a current image frame.

13. The electronic device of claim 12, wherein the tiles of image data are compressed when generated.

14. The electronic device of claim 12, comprising image processing circuitry configured to read the selected one of the plurality of framebuffers.

15. The electronic device of claim 14, wherein the image processing circuitry is configured to decompress the tiles of image data.

16. The electronic device of claim 12, comprising a processor configured to operate as a display controller to control which of the plurality of framebuffers supplies the one or more of the tiles for display on the electronic display.

17. The electronic device of claim 16, wherein the display controller is configured to identify a tile or a row of tiles comprising the highest-quality version of the one or more of the tiles.

18. A method comprising:
reading a first tile of image data of a first tile row into image processing circuitry for display on an electronic display; and
reading a second tile of image data of the first tile row next to the first tile of image data into the image processing circuitry for display on the electronic display, wherein the first tile and the second tile correspond to different qualities of data but are displayed on the electronic display at the same time.

19. The method of claim 18, wherein the first tile comprises a resolution greater than a threshold resolution and the second tile comprises a resolution less than the threshold resolution.

20. A method comprising:
generating tiles of image data corresponding to an image frame;
writing the tiles corresponding to the image frame in a first pass into a first framebuffer;
rendering, in a second pass, the tiles corresponding to the image frame in a second framebuffer; and
displaying, based on a quality of each tile, the tiles of image data corresponding to the image frame in an order, wherein the order corresponds to how the image frame is viewed by a user.

21. The method of claim 20, wherein the order is a raster order.

22. The method of claim 20, wherein the order is not a raster order.

23. The method of claim 20, wherein the tiles of image data are generated by a camera and are written into the first framebuffer in the first pass directly from the camera.
